(19) United States
(12) Patent Application Publication
(10) Pub. No.: US 2025/0189703 A1
(43) Pub. Date: Jun. 12, 2025

(54) LARGE-SCALE DISTRIBUTED PHOTOELECTRIC INTELLIGENT COMPUTING ARCHITECTURE AND CHIP SYSTEM

(71) Applicant: TSINGHUA UNIVERSITY, Beijing (CN)

(72) Inventors: Lu FANG, Beijing (CN); Zhihao XU, Beijing (CN); Tiankuang ZHOU, Beijing (CN)

(21) Appl. No.: 18/754,400

(22) Filed: Jun. 26, 2024

(30) Foreign Application Priority Data
Dec. 6, 2023 (CN) 202311659650.2

(51) Int. Cl. G02B 5/18; G02B 26/10

(52) U.S. Cl. CPC G02B 5/1842; G02B 26/106; G02B 2005/1804

(57) ABSTRACT

A large-scale distributed photoelectric intelligent computing system, including: a diffractive compression encoder, configured to collect two-dimensional light field information through a grating array, convert the two-dimensional light field information into one-dimensional information through waveguide transmission and transmit the one-dimensional information to a first diffractive region, and perform computing using a diffractive coding weight to output a one-dimensional vector through an output end of the first diffractive region; a reconfigurable interference feature embedder consisting of an interferometer array composed of a plurality of thermo-optical phase modulators, in which the interferometer array is configured to perform a multiplication operation on the one-dimensional vector, to output a computed result in a one-dimensional vector form; and a diffractive decoder, configured for diffractive decoding the computed result in the one-dimensional vector form through a second diffractive region, to compute and output final light field information through a diffractive decoding weight.

### CROSS-REFERENCE TO RELATED APPLICATIONS

This application claims priority to Chinese Patent Application No. 202311659650.2, filed on Dec. 6, 2023, the entire disclosure of which is incorporated herein by reference.

### TECHNICAL FIELD

The disclosure relates to the technical field of artificial general intelligence (AGI) large model and silicon optical integrated photoelectric computing chip, in particular to a large-scale distributed photoelectric intelligent computing architecture and a chip system.

### BACKGROUND

As performance of computing architectures continues to improve, AGI develops rapidly. In order to perceive and process complex multimodal information from a real world, high-throughput and high energy-efficient computing architectures are needed. Continuous pursuit for high-performance computing presents major challenges for academia and industry in post-Moore era. Use of traditional electronic devices such as graphics processing unit (GPU) for artificial intelligence (AI) big model computing (e.g., big models for natural language processing, and medical big models, etc.) is commonly faced with problems such as huge energy overheads and limited inference speeds, which makes it difficult to continue to support development of advanced AI big models and AGI. The pursuit of a balance between computing throughput and efficiency has become a goal of high-performance computing research.

### SUMMARY

The disclosure aims to solve one of the technical problems in the related art at least to some extent.

A first aspect of the disclosure provides a large-scale distributed photoelectric intelligent computing system, including a diffractive compression encoder, a reconfigurable interference feature embedder, and a diffractive decoder, in which,
the diffractive compression encoder is configured to collect two-dimensional light field information using a grating array, convert the two-dimensional light field information into one-dimensional information through waveguide transmission and transmit the one-dimensional information to a first diffractive region, and perform a compute by using a diffractive coding weight, to output a one-dimensional vector through an output end of the first diffractive region;
the reconfigurable interference feature embedder consists of an interferometer array composed of a plurality of thermo-optical phase modulators, and the interferometer array is configured to perform a multiplication operation on the one-dimensional vector, to output a computed result in a one-dimensional vector form; and
the diffractive decoder is configured for diffractive decoding the computed result in the one-dimensional vector form using a second diffractive region, to compute and output final light field information through a diffractive decoding weight.

A second aspect of the disclosure provides a large-scale distributed photoelectric intelligent computing method. The method includes:
processing two-dimensional light field information of input samples in parallel using a parallel diffractive compression encoder and a diffractive decoder in chunks and regions, and compressing input two-dimensional light field information into a one-dimensional vector using a multilayer coding setup;
performing multi-bit binary coding for each category of a classification task based on the one-dimensional vector to obtain binary coding values, and obtaining a binarized code for each sample according to the binary coding values;
comparing the binarized code with a standard binarized code for each category using a minimized encoding Hamming distance to compute a distance between the binarized code and the standard binarized code, to obtain a computed result of distance; and
determining a standard category corresponding to a minimum distance in computed results of distance as a final classification discrimination result of the input samples to complete a computing task.

### BRIEF DESCRIPTION OF THE DRAWINGS

The above and/or additional aspects and advantages of embodiments of the disclosure will become apparent and more readily appreciated from the following descriptions made with reference to the accompanying drawings.

FIG. 1 is a block diagram of a large-scale distributed photoelectric intelligent computing system according to an embodiment of the disclosure.

FIG. 2 is a diagram of interconnection relation of components in a chiplet architecture according to an embodiment of the disclosure.

FIG. 3 is a schematic diagram of integrated photonics processing chiplets according to an embodiment of the disclosure.

FIG. 4 is a flowchart of a large-scale distributed photonics intelligent computing method according to an embodiment of the disclosure.

FIG. 5 is an actual microscopic shot of integrated photonics processing chiplets according to an embodiment of the disclosure.

FIG. 6 is a schematic diagram of a complete photonic neural network formed by multiplexing component chiplets according to an embodiment of the disclosure.

FIG. 7 illustrates accuracies of tests for a photonic neural network constituted by chiplets under different datasets according to an embodiment of the disclosure.

### DETAILED DESCRIPTION

It is noted that the embodiments of the disclosure and features in the embodiments may be combined with each other without conflict. The disclosure will be described in detail below with reference to the accompanying drawings in combination with the embodiments.

In order to enable those skilled in the art to better understand the embodiments of the disclosure, the technical solutions in the embodiments of the disclosure will be described clearly and completely in the following in combination with the accompanying drawings in the embodiments of the disclosure. Obviously, the described embodiments are only a part of the embodiments of the disclosure and not all of them. Based on the embodiments of the disclosure, all other embodiments obtained by those skilled in the art without inventive work shall fall within the scope of protection of the disclosure.

As a novel computing architecture, photonic computing has been receiving increasing attention, which provides unprecedented light-speed computing capabilities with extremely low energy consumption and offers new architectural ideas for high-performance computing. Recent researches related to optical computing provide various forms of photonic computing architectures. For example, high parallelism of free-space optics can realize basic image operator feature extraction, reservoir computing, deep neural network, and on the like. Meanwhile, a development of integrated photonics is expected to achieve optoelectronic integrated photonic computing chips with higher spatial efficiency and lower energy consumption, and has been used to construct a variety of on-chip neural networks to implement intelligent tasks. For example, a Mach-Zehnder interferometer (MZI) array realized on chip has been used to construct a real-valued neural network and a complex-valued neural network. On-chip two-dimensional optical diffractometers have also been used for optical matrix multiplication. By means of device multiplexing, more complex neural network operations, such as two-dimensional image operations in a convolutional neural network, can be implemented by means of a photonic convolutional kernel. However, the current scale of photonic integrated circuit (PIC)-based photonic computing, especially on-chip optical neural network (ONN), is usually at a level of hundreds to thousands of parameters, and there are only dozens of reconfigurable adjustable parameters, and thus only simple and basic machine learning tasks are supported, such as simple pattern recognition, vowel audio classification, and the like. It is difficult for on-chip ONNs to achieve larger neural network computing scales. Despite advantages in spatial compactness and energy efficiency, current PICS still suffer from inevitable time-varying on-chip computing physical errors. The computational power is limited by limited network scale and number of parameters, and at the current stage, the PICs is far from being able to meet a requirement of a real-world AGI large model tasks in the real world.

In order to realize large-scale, high energy-efficient on-chip photonic computing, simply expanding a physical scale of an existing photonic neural network chip at a wafer level or simply multiplexing a single photonic chip is not a practical approach for the following reasons. The reasons include: (a) tens to hundreds of parameters of each reconfigurable optical device are required to map network parameters, each reconfigurable optical device is at micron level, and it is challenging to accommodate a ONN with a large number of configurable parameters on a single wafer; (b) due to noises of devices and calibration errors, analog noises inevitably grow exponentially as the number of neural network layers increases, which makes it difficult to guarantee accuracy of large-scale ONNs; (c) two-dimensional spatial input (e.g., image input) has a large amount of redundancy, and information represented by each site is not completely independent from each other. Its effective amount of information can be compressed to a lower dimension, i.e., it can be efficiently processed on a smaller scale computing hardware. Therefore, simply expanding existing architectures cannot proportionally improve the computing performance and cannot effectively support a larger number of neural network parameters and a more complex intelligent computing task.

A large-scale distributed photoelectric intelligent computing system and method according to the embodiments of the disclosure are described below with reference to the accompanying drawings.

FIG. 1 is a structural diagram of a large-scale distributed photoelectric intelligent computing system 10 of an embodiment of the disclosure.

As illustrated in FIG. 1, the system 10 includes: a diffractive compression encoder 100, a reconfigurable interference feature embedder 200, and a diffractive decoder 300.

The diffractive compression encoder 100 is configured to collect two-dimensional light field information through a grating array, convert the two-dimensional light field information into one-dimensional information through waveguide transmission and transmit the one-dimensional information to a first diffractive region, and perform compute by using a diffractive coding weight, so as to output a one-dimensional vector through an output end of the first diffractive region.

The reconfigurable interference feature embedder 200 consists of an interferometer array composed of a plurality of thermo-optical phase modulators, and the interferometer array is configured to perform a multiplication operation of a unitary matrix based on the one-dimensional vector, to output a computed result in a one-dimensional vector form.

The diffractive decoder 300 is configured for diffractive decoding the computed result in the one-dimensional vector form using a second diffractive region, to compute and output final light field information by using a diffractive decoding weight.

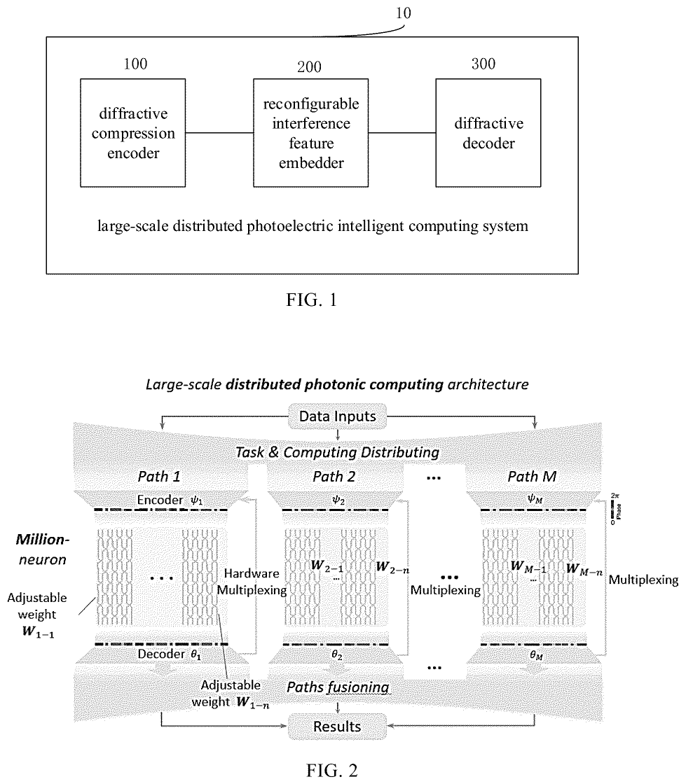

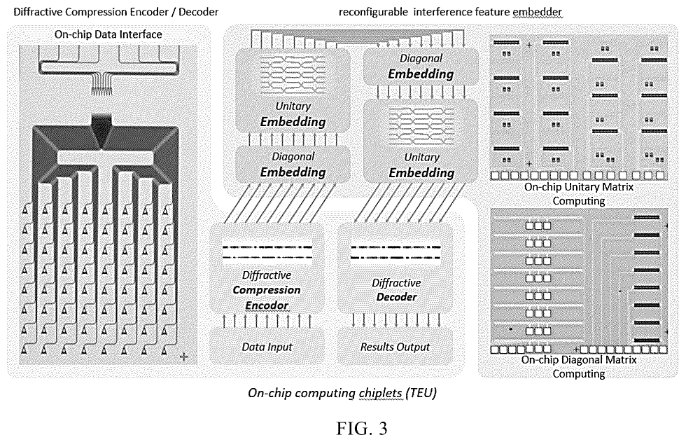

It is appreciated that the implementation of the system of the disclosure is realized based on an integrated optical interference-diffractive hybrid architecture of large-scale chiplets, as shown in FIGS. 2 and 3:

diffractive compression encoder M1, in an embodiment of the disclosure, is obtained by on-chip silicon photonics process, on-chip diffraction can realize multiple functions, such as on-chip diffraction is used for coding, compressing and decoding, and the like.

For example, the diffractive compression encoder, supports up to 64 channels of input, 8 channels of output, and a diffractive region size of 200 micrometers*300 micrometers, and up to 2 layers of coding weights, each containing 1024 parameters at most. These parameters are written into the diffractive region by double exposure in the form of etched air trenches.

In an embodiment of the disclosure, the input is a two-dimensional light field input. The two-dimensional light field is collected by the grating array, converted into one-dimension by waveguide transmission, and propagated by diffraction to arrive at a weight region consisting of air trenches for phase modulation, and then propagated by diffraction for a period of time to arrive at an output end and output in one-dimension.

In detail, data input is in the form of the grating array, using a total of 64 gratings arranged in 8*8, which are wired through waveguide to convert the original two-dimensional light field information into one-dimensional vector arrangement as the actual input to the diffractive region. Through passive processing of diffractive weights, an 8 times compressed encoding result can be obtained at the output end of the diffractive region. This coding result is a one-dimensional output.

For example, diffractive coding weights (etched air trenches of different lengths) can be obtained by machine learning gradient descent.

It is understood that due to irreversible nature of a double exposure etching process, the diffractive weights are usually non-reconfigurable and non-adjustable. Therefore, when training weights, a general large-scale dataset is used for training (a complete ImageNet dataset), to obtain more general and more universal diffractive coding weights.

It is understood that a diffraction process is modeled by an angular spectral model. The weights are arrays of air trenches with varying lengths processed by an electron beam exposure process, and the diffractive weights are represented by the lengths of these air trenches.

It is understood that since the physical processes of propagation and modulation can already be obtained by modeling, a simulation of these physical processes can be implemented on a machine learning platform, such as tensorflow platform, where the lengths of the air trenches are set as trainable parameters, and after a gradient descent optimization, a set of optimized length distributions of the air trenches can be obtained.

It is understood that the diffractive weights (the length distributions of the air trench) of the embodiments of the disclosure are used to perform a coding compression for input light field data. Depending on different computing tasks, specially trained weights allow the coding compression to be more specific and achieve better results under the computing task.

It is understood that although this operation is not conducive to achieving an extreme performance in a certain small-scale dedicated dataset, it is highly migratory and generalizable, and can support common coding dimension reduction operations for different datasets, to enhance the universality of this component and reduce hardware processing cost for computational content migration.

For example, a spatial light modulation device, such as a liquid crystal phase modulator device or a digital micromirror array, is usually used to construct a fluctuating light field with certain spatially distributed amplitude and phases. The fluctuating light field is focused at the grating array as information input to the diffractive compression encoder.

In conclusion, through the diffractive coding of the large-scale chiplets, dimensional redundancy of the two-dimensional information input is eliminated as much as possible, to make the computation more efficient. Since a diffractive computation is passive, energy efficiency is improved by up to two orders of magnitude compared to other AI chips.

For the reconfigurable interference feature embedder M2, it is known that the reconfigurable interference feature embedder is composed of multiple on-chip integrated MZI arrays. The on-chip integrated MZI arrays are integrated using a silicon photonics process. The on-chip integrated MZI arrays are to change dielectric constants of waveguide through an electrothermal effect of titanium nitride (TiN), and thus change a phase of any signal passing through this section of waveguide.

In detail, an input of the M2 is coding and compressing results of the M1, typically in the form of one-dimensional vectors. This input one-dimensional vectors are computed by the MZI arrays to obtain a new set of one-dimensional vectors with same lengths as the input. This new set of vectors is used as the output a computed result in a one-dimensional vector form of this component for the subsequent diffractive decoder M3 to continue the computing.

For example, based on this principle of basic thermo-optical phase modulation, the interferometer array can realize a matrix computation of input signal vectors. In detail, for the 8-channel signals output from the diffractive compression encoder of the aforementioned M1, the deployment of interferometer array consisting of 56 thermo-optical phase modulators can realize any 8*8 unitary matrix multiplication operation. Elements of the unitary matrix can be obtained by machine learning gradient descent training and mapped to phase change parameters of the phase shifter.

For example, in the reconfigurable interference feature embedder, two aforementioned unitary matrix multipliers are deployed along with the diagonal matrix multiplier, to realize modulation operation of an arbitrary matrix. Since the arbitrary matrix can be decomposed into a product of one unitary matrix, one diagonal matrix, and another unitary matrix by means of singular value decomposition (SVD), the interferometer array deployed above can realize the multiplication operations of arbitrary matrix.

In the embodiments of the disclosure, the reconfigurable interference feature embedder has a programmable reconfigurable capability. Depending on differences of computing contents, a supply voltage of each phase shifter can be dynamically adjusted in real time to realize multiplication of different matrices. With this reconfigurable interference feature embedder, the disclosure has a capability of multiplexing hardware to realize larger-scale neural network computation. Generally, this embedder is used for feature embedding computation of encoded information.

In the embodiment of the disclosure, reconfigurable multiplexing of computational functions is integrally realized by the reconfigurable interference feature embedder and a diffractive compression encoder with global training weights. Although the adjustable network weights only correspond to interference computing portion, there is no obvious constraint on richness of network functions, which proposes a new solution idea for economy and convenience of photonic chip reconfiguration.

The diffractive decoder M3 may be understood as an on-chip diffractive decoder integrated by using the silicon photonics process.

For example, the diffractive decoder M3 may diffractive decode the 8-channel information, i.e., the computed result in the one-dimensional vector form, output from the reconfigurable interference feature embedder M2, and outputs the final light field information.

It is understood that the hardware design of M3 is dual with the diffractive compression encoder M1. Decoding weights of M3 are also obtained by global data training (with a same dataset as that of the coder M1). The diffractive region of the diffractive decoder is etched with air diffractive trenches with different length distributions by the same double exposure etching process as the coder M1. By the passive compute of the decoding weights, up to 64 channels of decoded data can be supported for final output in the form of 8*8 grating arrays, which are received using photoelectric diode arrays.

The information importing and collecting interface array M4 is also included. It is understood that since the disclosure is not a single chip with fixed input and output limitations, but rather independently usable chiplets consisting of a plurality of the foregoing components. The disclosure may be deployed with a plurality of data interfaces to read computed results from any component or input data to be computed to any component.

In detail, the aforementioned components M1-M3 may either operate independently or be used in combination as a combined component. For example, M1 and M2 may form a reconfigurable compression and compute coder Ma, and the computed results of Ma constitute a new two-dimensional data, which is input into a new M1 for further coding and compressing, thereby realizing multilevel coding, and compressing information and reducing dimensional redundancy of the original data to a maximum extent. Similarly, a larger-scale decoder array can be formed by combining the components M2 and M3.

As a result, a task with larger computational complexity is solved in a distributed manner by parallelized splitting a computing task, which provides new ideas for simplified processing of complex future AI models.

In conclusion, through cascading multiplexing and combination of multiple components as described above, the photoelectric chiplets proposed in the disclosure have the ability to handle large-scale high-resolution two-dimensional input and output. For complex AI tasks at current stage, the design of chiplets has the potential to support larger-scale network parameters and computational capabilities.

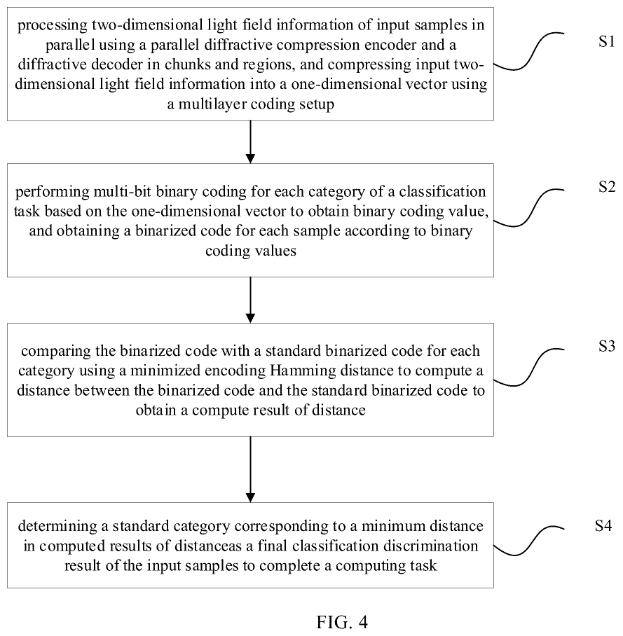

FIG. 4 is a flowchart of a large-scale distributed photonics intelligent computing method according to an embodiment of the disclosure. The method includes:
S1, processing two-dimensional light field information of input samples in parallel using a parallel diffractive compression encoder and a diffractive decoder in chunks and regions, and compressing the input two-dimensional light field information into a one-dimensional vector using a multilayer coding setup;
S2, performing multi-bit binary coding for each category of a classification task based on the one-dimensional vector to obtain binary coding values, and obtaining a binarized code for each sample according to the binary coding values;
S3, comparing the binarized code with a standard binarized code for each category using a minimized encoding Hamming distance to compute a distance between the binarized code and the standard binarized code to obtain a computed result of distance; and
S4, determining a standard category corresponding to a minimum distance in computed results of distance as a final classification discrimination result of the input samples to complete a computing task.

In an embodiment of the disclosure, a single component or a combination of several components is multiplexed to achieve support for larger-scale input data according to a modular chiplets hardware architecture in the disclosure. In the actual processing of chiplets, the diffractive compression encoder and diffractive decoder support at most 64 channels of data, but for the two-dimensional data in practical applications, it often requires tens to hundreds of pixels on a single side dimension, overall demand for the number of channels is often tens of thousands, which is obviously difficult to be supported by a single piece of hardware. In order to solve this problem, a distributed expanding approach for computational hardware resources is proposed, i.e., using the parallel diffractive compression encoder and diffractive decoder to process large-scale input data in parallel in chunks and regions. Each diffractive compression encoder and diffractive decoder only needs to code or decode a certain small 8*8 region in the two-dimensional input, and uses a multi-layer coding setup (8 times compression in each layer, i.e., multiplexing multi-layer parallel coding and decoding hardware) to compress the high-dimensional input data into low-dimensional data with fewer redundancy for computation.

In an embodiment of the disclosure, direct processing for a large complex task often a larger neural network size. In conventional electrical computing, establishing a large neural network is not difficult due to high robustness of digital computation. However, for ONNs based on analog computation, too deep layers may cause device errors to be accumulated between layers, which ultimately affects the computed result. In order to solve the conflict between the network size and the task complexity, the disclosure proposes to split a deep large neural network into multiple parallel shallow neural networks, which can realize the same function. Under this design idea, a computing task with higher complexity will be split into multiple sub-tasks with lower complexity. For example, a multi-classification task, such as ImageNet, which is a 1000 classification task, will be split into 10 independent binary classification tasks. In each binary classification task, 1000 categories are reallocated randomly into two categories, and this binary classifier will decide which of these two large categories each sample belongs to. For a second classification of categories of these 10 sub-classifiers, a principle of independence and homogeneity is followed, i.e., each second classification will ensure that the numbers of positive and negative categories are basically the same (both around 500), and the classification methods are independent of each other, to enhance the independence of the result of each sub-classifier. In other words, the disclosure performs 10-bit binary coding on each of these 1000 categories. Each binary sub-classifier determines the binary code value of a corresponding bit, and ultimately yield a final 10-bit binary category code for each sample as a representation of the final classification result. It is noted that this distributed computing method also has the potential for incremental accuracy improvement. For example, the disclosure may expand the differences between codes of each category by introducing an 11th binary classification encoder to an original system with 10 sub-classifiers, and thus improve the accuracy. By using this method for splitting and simplifying a task, the architecture of chiplets proposed in the disclosure can complete the computation of each binary sub-classifier by establishing a 6-layer deep photonic neural network. By adding incremental boosts of additional classifiers, overall accuracy is increased to an accuracy level equivalent to accuracy of electrical computing with 1000 classifications at the current stage.

In an embodiment of the disclosure, under the aforementioned distributed computing architecture, a large-scale computing task is decomposed in parallel decomposition and computed by a photonic neural network, to obtain a binarized sequence representing the final result. At this step, the binarized sequence is further converted into a final classification result representation. The disclosure uses a principle of minimizing a coding Hamming distance or minimizing a Euclidean distance, to compare the binarized code output of the input sample with the standard binarized code of each category, and computes a distance between the binarized code and the 1000 standard codes, and takes the standard category corresponding to the minimum distance as the final classification discrimination result of this input sample, and completes the overall computing task.

In conclusion, the disclosure eliminates the dimensional redundancy of two-dimensional information input as much as possible through the diffractive coding and decoding of the large-scale chiplets, which makes the computation more efficient. Since the diffractive computing is passive, the energy efficiency is improved by up to two orders of magnitude compared to other AI chips. Through the reconfigurable interference feature embedder and the diffractive compression encoder with global training weights, the overall reconfigurable multiplexing of computational functions is realized. Although the adjustable network weight only corresponds to interference computing portion, there is no obvious constraint on richness of network functions, which proposes a new solution idea for the economy and convenience of photonic chip reconfiguration. The task with larger computational complexity is solved in a distributed manner by parallelized splitting the computing task, which provides new ideas for simplification processing of complex future AI models. It greatly extends a scale advantage and low energy consumption advantage of photonic neural network computing, which ultimately empowers AGI and large-scale network photonic computing.

Further, the disclosure breaks the limitations of traditional photonic computing chips based on a single structure with respect to limited computational scale and insufficient multiplexing expansion capability, and provides the possibility for on-chip integrated photoelectric neural networks using the silicon optical process to process complex multi-dimensional tasks and realize large-scale photonic neural networks at the level of ten million neurons.

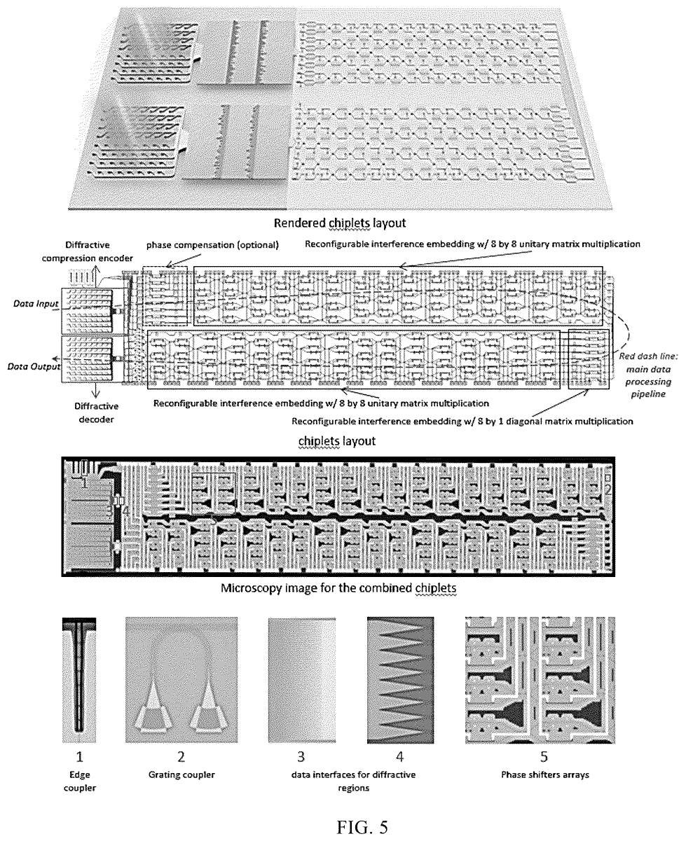

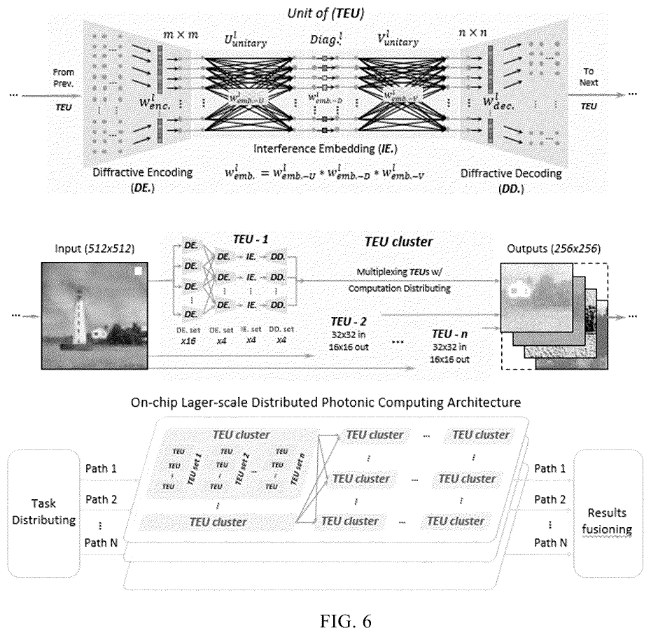

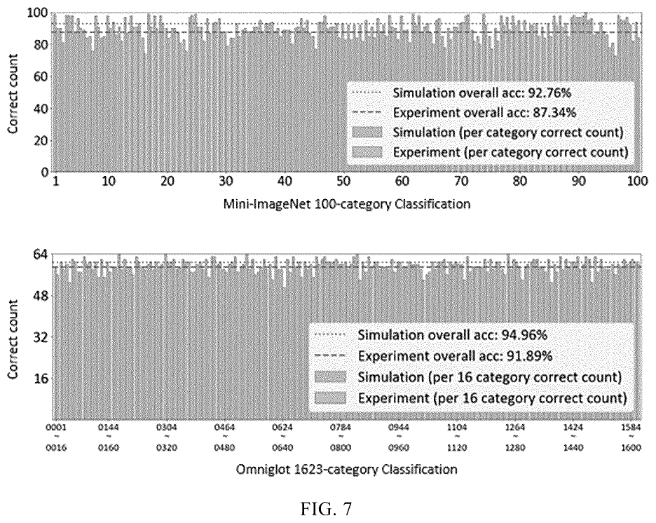

The validation of the large-scale distributed photoelectric intelligent computing method of the embodiments of the disclosure is shown below with reference to FIGS. 5, 6 and 7.

It is understood that the disclosure uses the mini-ImageNet 100 classification dataset to illustrate the application method and the computational process of the disclosure. Each sample in this dataset is a three-channel color image data with a resolution of 64*64 pixels. The output shall be a classification prediction for each sample. The computational process can be macroscopically divided into two main steps, one of which is the distributed deployment of computational resources, i.e., realizing a complete neural network with a certain size by hardware multiplexing the invented chiplets. Second, the decomposition and distributed parallel processing of the tasks to be computed, i.e., splitting a complex multi-category classification task into several parallel binary classification tasks while obtaining computed results of these binary classification. Finally, the multiple binary classification results are fused to output the final classification result.

In detail, for each sample, in the disclosure, original 64*64 dimensional data is first compressed into 64*8 channels using 64 M1, i.e., 64-channel diffractive compression encoders, and then the compressed data is further compressed into 8*8 channels using 8 reconfigurable compression and compute encoders Mas. Each of Mas is composed of M1 and M2. This 64-channel coded information is further input to 8 M2 for computation, and then up-sampled to 64*8 channels using the 8 groups of M2 and M3, and recovered to 32*32 channel scale using 4 groups of output interfaces and M3.

After the above component combination multiplexing computation, a layer of on-chip photonics computation with two times down-sampling is completed. In a similar manner, a set of binary classification sub-networks consisting of six layers of the above computation manner is established in the disclosure, and each sub-network operates separately and independently to obtain a series of binary classification results. In practical experiments, accuracy of each binary classification can reach 92%. Finally, by deploying a total of 17 binary classification sub-classifiers, a photonic neural network with a total amount of parameters of 13.96M is established in the disclosure, which achieves the accuracy greater than 90% in a total of 100 classifications, and achieves the similar accuracy performance of electrical computing at the current stage. Meanwhile, due to a passive nature of the diffractive compression encoder and diffractive decoder, and the low-power consumption of the reconfigurable interference feature embedder, power consumption of integrated on-chip computation is reduced by 2 orders of magnitude relative to other AI specific chips, thereby reaching a maximum level of 140 TOPS/W.

The integrated photonics on-chip hybrid photoelectric diffractive-interference large-scale neural network used in the embodiments has the following characteristics. First, the network structure is flexible and variable. Due to the manner using modular diffractive and interference computing units in the disclosure, a network construction scale can be flexibly selected according to task difficulty and accuracy requirement, and different network functions can be realized by controlling M2, to complete the computing of large-scale complex tasks using a most reasonable scale and structure. Second, the network scale is incrementally scalable. Since the complex task is split into multiple simple sub-tasks, more sub-tasks can be introduced to incrementally improve the final task performance. Third, the power consumption of computation is extremely low. Due to the use of passive diffractive compression encoder and diffractive decoder, multiple data coding and decoding operations can be accomplished without additional power supply, which ensures controllable power consumption during large model computation.

The information processing process involved in the disclosure has been validated with multiple datasets and shows high robustness, stability and accuracy. Meanwhile, the flexible and variable network structure gives the disclosure high adaptability and migration.

Reference throughout this specification to “an embodiment,” “some embodiments,” “an example,” “a specific example,” or “some examples,” means that a particular feature, structure, material, or characteristic described in combination with the embodiment or example is included in at least one embodiment or example of the disclosure. The schematic representations of the above terms in various places throughout this specification are not necessarily referring to the same embodiment or example of the disclosure. Furthermore, particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply the relative importance or implicitly specify the number of technical features indicated. Therefore, the feature defined with “first” and “second” may explicitly or implicitly include at least one such feature. In the description of the disclosure, “a plurality of” means at least two, for example, two or three, unless specified otherwise.

What is claimed is:

1. A large-scale distributed photoelectric intelligent computing system, comprising a diffractive compression encoder, a reconfigurable interference feature embedder, and a diffractive decoder; wherein:
the diffractive compression encoder is configured to collect two-dimensional light field information through a grating array, convert the two-dimensional light field information into one-dimensional information through waveguide transmission and transmit the one-dimensional information to a first diffractive region, and perform computing by using a diffractive coding weight to output a one-dimensional vector through an output end of the first diffractive region;
the reconfigurable interference feature embedder consists of an interferometer array composed of a plurality of thermo-optical phase modulators, and the interferometer array is configured to perform a multiplication operation on the one-dimensional vector, to output a computed result in a one-dimensional vector form; and
the diffractive decoder is configured for diffractive decoding the computed result in the one-dimensional vector form through a second diffractive region, to compute and output final light field information through a diffractive decoding weight.

2. The system of claim 1, further comprising an information importing and collecting interface array, wherein the information importing and collecting interface array is disposed in the diffractive compression encoder, the reconfigurable interference feature embedder, and the diffractive decoder, respectively, and the information importing and collecting interface array is configured to read multiple of the one-dimensional information, the one-dimensional vector, the computed result in the one-dimensional vector form, and the final light field information.

3. The system of claim 1, wherein the diffractive compression encoder and the reconfigurable interference feature embedder form a reconfigurable compression and compute coder, computed results of data of the reconfigurable compression and compute coder form a two-dimensional dataset and the two-dimensional dataset is compressed by inputting into a new diffractive compression encoder.

4. The system of claim 1, wherein the first diffractive region and the second diffractive region are each made up of air trenches of different lengths, respectively, corresponding basic parameters of the first diffractive region and the second diffractive region are written into the first diffractive region and the second diffractive region by means of etched air trenches and a double exposure process, respectively, and the diffractive coding weight and the diffractive decoding weight are obtained by training a preset training dataset, respectively.

5. The system of claim 1, wherein the diffractive compression encoder, the reconfigurable interference feature embedder, and the diffractive decoder are obtained by on-chip integration using a silicon photonics process.

6. The system of claim 1, wherein a fluctuating light field having spatially distributed amplitude and phases is constructed using a spatial light modulation device, to make the fluctuating light field focus at the grating array and serve as input data of the diffractive compression encoder.

7. The system of claim 1, wherein the two-dimensional light field information is a 64-channel signal, and each of the one-dimensional vector, the computed result in the one-dimensional vector form, and the final light field information is an 8-channel signal.

8. The system of claim 1, wherein two unitary matrix multipliers and a diagonal matrix multiplier are deployed on the interferometer array for decomposing an arbitrary matrix into a product of a first unitary matrix, a diagonal matrix, and a second unitary matrix through singular value decomposition, to realize a multiplication operation of the arbitrary matrix.

9. The system of claim 8, wherein elements of the first unitary matrix or the second unitary matrix are obtained by machine learning gradient descent training and mapped to phase change parameters of a phase shifter of the interferometer array.

10. The system of claim 9, wherein supply voltage of the phase shifter is dynamically adjusted in real time to realize multiplication of different matrices.

11. A large-scale distributed photoelectric intelligent computing method, comprising:
processing two-dimensional light field information of input samples in parallel using a parallel diffractive compression encoder and a diffractive decoder in chunks and regions, and compressing input two-dimensional light field information into a one-dimensional vector using a multilayer coding setup;
performing multi-bit binary coding for each category of a classification task based on the one-dimensional vector to obtain binary coding values, and obtaining a binarized code for each sample according to the binary coding values;
comparing the binarized code with a standard binarized code for each category using a minimized encoding Hamming distance to compute a distance between the binarized code and the standard binarized code to obtain a computed result of distance; and
determining a standard category corresponding to a minimum distance in computed results of distance as a final classification discrimination result of the input samples to complete a computing task.

12. The method of claim 11, wherein each of the binary coding values are determined by a binary sub-classifier.

13. The method of claim 11, wherein the binarized code for each sample comprises a plurality of bits, and each of the binary coding values corresponds to a bit.
